(19) United States
(12) Patent Application Publication
(10) Pub. No.: US 2026/0346832 A1
(43) Pub. Date: Nov. 5, 2026

(54) System and Method for Increasing the Eye Safety of Vehicle Occupants

(71) Applicant: Bayerische Motoren Werke Aktiengesellschaft, Muenchen (DE)

(72) Inventors: Jonathan FISCHER, Karlsfeld (DE); Faraz QUREISHI, Muenchen (DE)

(21) Appl. No.: 19/489,763

(22) PCT Filed: Jul. 5, 2024
(86) PCT No.: PCT/EP2024/068997

§ 371 Date: Dec. 3, 2025

(30) Foreign Application Priority Data
Aug. 23, 2023 (DE) 10 2023 122 603.7

(51) Int. Cl. B60W 10/30; G01S 17/931

(52) U.S. Cl. CPC B60W 10/30; G01S 17/931; B60W 2540/225; B60W 2710/305

(57) ABSTRACT

A system for increasing the eye safety of occupants of a vehicle fitted with a laser scanner includes a reflection light detector for detecting reflected light which was emitted by the laser scanner and was reflected by an object located outside of the vehicle onto a vehicle window of the vehicle, and a control device which is designed, depending on the detection of the reflected light by the reflection light detector, to generate control signals for influencing a light emission of the laser scanner.

### BACKGROUND AND SUMMARY

The invention relates to a system and a method for increasing the eye safety of occupants of a vehicle equipped with a laser scanner. Furthermore, the invention relates to a vehicle equipped with such a system.

Modern motor vehicles are equipped with numerous sensors that control the operation of various driver assistance functions or automated driving functions. In addition to cameras, radar sensors and ultrasonic sensors, automated driving systems are increasingly using lidar sensors, which use a laser scanner to scan the surroundings of the vehicle, to detect the surroundings of a vehicle. Such laser scanners use pulsed, strong laser sources.

In general, aspects of eye safety must be taken into account when using lasers. Lidar sensors must therefore be certified as eye safe. They are usually designed as passively eye safe systems. Lidar sensors apply here—viewed in isolation—as passively eye safe if they only emit so much light output that a hazard to persons is excluded. With modern lidar sensors, however, the light power emitted per laser pulse continues to increase. This trend is only limited by the current performance of laser diodes.

In the case of lidar sensors that are not designed to be passively eye safe, active eye safety measures can be used. In particular, a distance to a nearest surface can be actively monitored. If the distance becomes too small, the laser scanner is stopped so that no further laser pulses are emitted. Such lidar sensors are described as actively eye safe.

As mentioned, taken on their own (i.e. considered as an isolated device) lidar sensors are designed to be eye safe and are certified accordingly. However, if external surfaces which can act as additional optics come into play in the application, configurations are theoretically conceivable in which a relatively large amount of light power is nevertheless reflected back in the direction of a vehicle on which the lidar sensor is located. For example, surfaces of other vehicles, house walls, traffic signs and the like, which have a concave curvature, act like a focusing mirror (in the manner of a concave mirror) and reflect an essentially collimated laser beam emitted by the laser scanner as a focused laser beam back to the vehicle. As a result, an increased light intensity could possibly get into the eyes of a vehicle occupant. The probability that a vehicle occupant of the vehicle equipped with the laser scanner emitting the laser light is affected by this is relatively high—compared to the probability that, for example, passers-by or vehicle occupants of other vehicles are affected—because vehicle occupants spend the longest time in the vicinity of the laser scanner and relative to it in the same place. Overall, the probability of such a scenario occurring can be assumed to be very low, since the laser beam must hit a concave surface in a very specific direction, which must be suitable in terms of its radius of curvature, orientation, and reflectivity to reflect the laser beam back to the vehicle in a focused manner. Nevertheless, the probability of occurrence is greater than zero, especially since a lidar is a scanning system that scans many different surfaces in different directions in a short time.

Based on this, one of the objectives of the present invention is to specify a system and a method which are suitable for improving the eye safety of occupants of a vehicle which is equipped with a laser scanner.

This objective is achieved by the features disclosed herein. Advantageous embodiments are described in the present disclosure.

It should be noted that additional features of a claim dependent on an independent claim but without the features of the independent claim or only in combination with a subset of the features of the independent claim can constitute an invention in its own right that is independent of the combination of all the features of the independent claim and that can be made the subject of an independent claim, a division application or a subsequent application. This applies in the same way to knowledge described in the description which may constitute an invention that is independent of the features of the independent claims.

A first aspect of the present invention relates to a system for increasing the eye safety of occupants of a vehicle equipped with a laser scanner.

The system contains a reflection light detector for detecting reflected light emitted by the laser scanner that has been reflected from an object outside the vehicle to a vehicle window of the vehicle (and, if appropriate, through the vehicle window into the interior of the vehicle).

In particular, the vehicle window can be a front window (windshield) of the vehicle. Alternatively or additionally, the vehicle window can also be a side window (for example if the laser scanner is a side lidar or is part of a side lidar) or a rear screen of the vehicle.

In addition, the system contains a control device that is configured to generate control signals to influence the light emitted by the laser scanner, depending on the detection of the reflected light by the reflection light detector.

For example, the control device can be connected for signal exchange to the reflection light detector on the one hand and to the laser scanner on the other. The control device may be configured to receive information signals from the reflection light detector about the detected light, to generate the control signals depending on the information signals and then to transmit the control signals to the laser scanner in order to cause the light output of the laser scanner to be changed depending on the detected reflected light.

According to an embodiment, the control device is configured to transmit the control signals in in such a way that, depending on the detection of the reflected light, they cause a reduction (in particular temporary) of the intensity of the light emitted by the laser scanner. In particular, the control device can be configured, depending on the detection of the reflected light, to generate control signals for (especially temporary) deactivation of the laser scanner. This means that in a situation where too much light intensity is reflected into the vehicle interior, the laser source can be switched off immediately to safely prevent the eyes of one or more vehicle occupants from being (further) exposed to the increased light intensity.

It is also within the scope of the invention that the system can be configured to generate the control signals by the control device depending on an intensity of the light detected by the reflection light detector. The intensity can be understood in particular to be an (area) power of the detected electromagnetic radiation. Preferably, the system is also configured to resolve the intensity of laser pulse peaks, i.e. not just to take into account an intensity averaged over several laser pulses for the purpose of controlling the laser scanner. The reason for this is that the power peaks of the laser pulses can be significantly stronger than the time-averaged intensity.

For example, an information signal of the kind mentioned above, which the control device receives from the reflection light detector, may contain information about the intensity of the detected light that the control device takes into account when it generates the control signals. However, it is also conceivable that the reflection light detector itself already filters according to relevant intensities and, for example, only transmits an information signal to the control device in the case of a relevant intensity.

According to a development, the system is configured to determine a location (in particular a point of impact on the vehicle window) and/or a direction of the light reflected to the vehicle window and to generate the control signals by the control device depending on the determined location and/or direction. The determination of location and/or direction can be carried out, for example, by the reflection light detector and/or by the control device.

It is also within the scope of the invention that the system can have an eye position and/or direction of view detection device (such as a so-called eye tracking system). The control device can then be configured to generate the control signals depending on an eye position and/or direction of view of a vehicle occupant detected by an eye position and/or direction of view detection device. This allows the laser scanner to be attenuated or deactivated more selectively, for example only when a vehicle occupant views a (potentially) relevant area, such as the windscreen or a certain area of the windscreen, or when the reflected light falls in the direction of one of the occupants' eyes.

In particular, the control device may be configured to produce the control signals depending on the determined direction of view and/or eye position in relation to a determined location and/or to the determined direction of the light reflected to the vehicle window. For example, the control device can make a comparison between the detected location or direction of the light reflected to the vehicle window and the detected eye position and/or direction of view of one or more vehicle occupants and to generate control signals to attenuate or deactivate the laser scanner only if there is a possibility that the reflected light (if appropriate with a certain minimum intensity) will fall into the eye of a vehicle occupant. It is also conceivable that the reflection light detector (optionally: only) monitors those areas of the vehicle window that are relevant due to the detected eye position or direction of view of a vehicle occupant.

The reflection light detector can be used to detect light in the infrared (IR) spectral range, especially in a wavelength range that the laser scanner uses. Common lidar wavelengths are for example 905 nm or 1550 nm. The reflection light detector can therefore be an IR-sensitive camera in particular or can contain one. An IR-sensitive camera can be understood as an IR-sensitive photodiode together with upstream optics.

Alternatively or additionally, the reflection light detector can be configured to detect light in the spectral range visible to humans. The reflection light sensor can therefore be for example a camera that works in the visible spectral range.

For example, the vehicle window can be provided with a fluorescent agent that initially makes non-visible light (for example infrared light) visible in a wavelength range that is (also) used by the laser scanner, so that this “translated” light can also be captured by a camera designed for the visible spectral range. The fluorescent agent can be chosen in such a way that it responds to the lidar wavelength, which can be particularly in the IR spectral range, and at the same time is sufficiently optically transparent to allow the unobstructed view through the vehicle window under normal conditions. Fluorescent agents of this type are used, for example, in residual light amplifiers (night vision devices).

According to a development, the fluorescent agents can be selected in a targeted manner and introduced into the vehicle window (for example with a certain concentration) so that they only respond from a defined intensity threshold of the light incident on the vehicle window, i.e. begin to glow in the visible spectral range. In this way, an intensity measurement or test that can be used to determine whether the reflected light is incident with an intensity that is relevant to triggering the safety measure (i.e. switching off or attenuating the laser scanner), can be advantageously carried out directly through the vehicle window provided with the fluorescent agent.

In general, the reflection light detector can be configured to detect light based on a spectral property, such as a characteristic frequency or frequency wavelength range used by the laser scanner. The system as a whole can be configured to generate the control signals by the control device depending on a spectral property of the detected light.

The reflection light detector—for example in the form of a camera for visible and/or infrared light—can be placed in the vehicle interior in such a way that it can observe the vehicle window or selected areas of the vehicle window from the inside and thus directly detect the incident reflected light or the light produced by the fluorescent agent. For example, such a camera may be located near a position where the head of a driver of the vehicle is usually located, such as approximately in an area above the driver's head. It is also possible to arrange the camera between the front seats to allow the camera to see the vehicle window.

However, it is also within the scope of the invention that the reflection light detector contains an Interior camera. The interior camera can be directed into the vehicle interior, for example, such as a so-called driver's camera directed at the driver from the front. For example, such a driver camera in the form of a Driver Monitoring Camera (DMC) can be integrated into a vehicle instrument cluster, which allows the driver's face to be observed particularly well.

For example, the interior camera can detect the reflected light based on a spectral property (for example on the basis of a characteristic frequency or wavelength range that the laser scanner uses) after it has entered the vehicle interior through the vehicle window and has been reflected and/or scattered on a structure (such as a vehicle seat) in the vehicle interior and/or on a vehicle occupant (such as on the forehead or face of a vehicle occupant). The camera can therefore observe the driver's face, for example. If the interior camera detects light in a relevant spectral range with a certain minimum intensity, the control device can output a control signal to attenuate or deactivate the laser scanner.

A second aspect of the invention is a vehicle that has a laser scanner, a vehicle window, and a system for increasing eye safety according to the first aspect of the invention. The reflection light detector of the system is configured to detect reflected light emitted by the laser scanner that has been reflected from an object outside the vehicle to the vehicle window.

The vehicle may be a road motor vehicle, such as a passenger car.

The vehicle can be configured for automated driving. The term “automated driving” is understood in the context of the document to mean driving with automated longitudinal and/or lateral guidance. Automated driving can be, for example, driving on the freeway for a longer period of time or driving for a limited period of time as part of parking. The term “automated driving” includes automated driving with any degree of automation. Exemplary degrees of automation are assisted, semi-automated, conditionally automated, highly automated, and fully automated driving (with an increasing degree of automation in each case). The five levels of automation mentioned above correspond to SAE levels 1 to 5 of the SAE J 3016 (SAE—Society of Automotive Engineering) standard as of Apr. 30, 2021. During assisted driving (SAE Level 1), the system performs longitudinal or lateral guidance in certain driving situations. During semi-automated driving (SAE Level 2), the system takes over longitudinal and lateral control in certain driving situations, wherein the driver has to continuously monitor the system as in assisted driving. During conditionally automated driving (SAE Level 3), the system takes over longitudinal and lateral guidance in certain driving situations without the driver having to constantly monitor the system; however, the driver must be able to control the vehicle through the system on request within a certain period of time. During highly automated driving (SAE Level 4), the system takes over the control of the vehicle in certain driving situations, even if the driver does not respond to a request for intervention, so that the driver is eliminated as a fallback level. During fully automated driving (SAE Level 5), the system can take over all aspects of the dynamic driving task under any road and environmental conditions which can also be mastered by a human driver.

In particular, the vehicle can be configured to perform an automated driving function in accordance with SAE Level 3 or higher, which uses the laser scanner for environment detection. During automated driving according to SAE Level 3 (or higher), the driver does not have to look at the road and can instead watch a film, for example.

With regard to driving comfort, it is therefore desirable that, in particular, an automated driving function in accordance with SAE Level 3 (or higher) as stable and uninterrupted as possible is provided. However, if the laser scanner were to be temporarily deactivated, the automated driving function might have to be discontinued or downgraded (for example to an SAE Level 2 function). The driver would then be disturbed by a notice to take over or notice that he had to look at the road. It is therefore desirable to avoid unnecessarily deactivating the laser scanner. For this reason, deactivating the laser as selectively as possible, which, as described above, only deactivates the laser scanner if the detected reflected light is relevant taking into account the eye position and/or direction of view of a vehicle occupant, can be used particularly advantageously for an automated driving function according to SAE Level 3 (or higher).

As described above with reference to an embodiment of the system according to the first aspect of the invention, the vehicle window of the vehicle according to the second aspect of the invention can be provided with a fluorescent agent which initially makes visible light that is invisible (for the human eye) in a wavelength range that the laser scanner uses.

A third aspect of the invention relates to a method for increasing the eye safety of occupants of a vehicle equipped with a laser scanner, wherein the method involves the following steps: detecting, by a reflection light detector, reflected light emitted by the laser scanner which has been reflected from an object located outside the vehicle to a vehicle window of the vehicle; and generating, by a control device, control signals to influence the light output of the laser scanner depending on the detection of the reflected light by the reflection light detector.

According to a development, as a further step of the method it may be provided that the location and/or direction of the light reflected to the vehicle window is determined. The generation of the control signals can then be carried out depending on the determined location and/or direction.

Alternatively or additionally, as a further optional step of the method it may be provided that an eye position and/or a direction of view of one or more vehicle occupants is determined. In this case, the generation of control signals can be carried out depending on the determined eye position and/or depending on the determined direction of view of the vehicle occupant(s).

Furthermore, as a further optional step, a comparison of the determined eye position and/or direction of view of the vehicle occupant(s) can be made with the determined location and/or with the determined direction of the light reflected to the vehicle window. The control signals can then be generated depending on the determined eye position and/or direction of view in relation to the determined location and/or direction of the light reflected to the vehicle window.

The above and following remarks on the system according to the first aspect of the invention can also be applied in an analogous manner to the vehicle according to the second aspect of the invention and to the method according to the third aspect of the invention. In particular, it should be noted that advantageous exemplary embodiments of the method according to the invention that are not explicitly described at this point and in the patent claims can correspond to the advantageous embodiment of the system according to the invention described in the description or in the patent claims and vice versa.

The invention is now explained in more detail by exemplary embodiments and with reference to the accompanying drawings. The features and combinations of features mentioned in the description and/or shown in the drawings alone can be used not only in the respective specified combination, but also in other combinations or on their own, without departing from the scope of the invention.

### BRIEF DESCRIPTION OF THE DRAWINGS

FIG. 1 shows schematically and by way of example a vehicle with a system for increasing the eye safety of vehicle occupants.

FIG. 2 shows a schematic flow diagram of a method for increasing the eye safety of vehicle occupants.

### DETAILED DESCRIPTION OF THE DRAWINGS

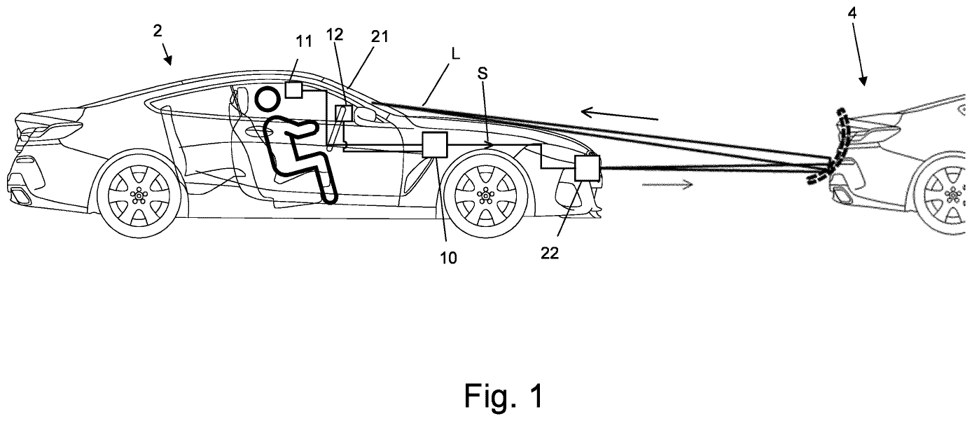

FIG. 1 shows schematically and by way of example a vehicle 2 equipped with a laser scanner 22. For example, in the scene shown, vehicle 2 is driving in an automated driving mode according to SAE Level 3, wherein the laser scanner 22 is scanning the surroundings of the vehicle.

In front of vehicle 2 is another vehicle 4 (vehicle ahead). A slightly divergent beam of light emitted by the laser scanner 22 falls on the rear of the vehicle ahead 4. The rear of the vehicle ahead 4 forms a concave curved reflective surface (schematically illustrated in FIG. 1 with a black dashed shape), which has a focusing effect on the light beam emitted by the laser scanner 22. As a result, as shown by way of example, reflected light L can fall with a comparatively high power on a vehicle window 21 (here a windscreen) of vehicle 2.

To prevent this intense light L from falling into the eyes of vehicle occupants of vehicle 2 for a long time, vehicle 2 is equipped with a system 1 for increasing eye safety.

The system 1 contains a reflection light detector 11 for detecting the reflected light L that has been emitted by the laser scanner 22 and that has been reflected onto a vehicle window 21 of vehicle 2 by an object 4 located outside vehicle 2.

In addition, the system 1 contains a control device 10, which is connected to the reflection light detector for signaling purposes and which is designed to generate control signals S for influencing a light emission of the laser scanner 22 depending on the detection of the reflected light L by the reflection light detector 11. The control device 10 is connected to the laser scanner 22 for signaling purposes for transmitting the control signals S.

The control signals S may be control signals S for reducing an intensity of the light emitted by the laser scanner 22, in particular for deactivating the laser scanner 22. In other words, the laser scanner 22 can be switched off immediately, especially if the reflection light detector detects light with a certain minimum intensity and with certain spectral properties that correspond, for example, to the light emitted by the laser scanner 22.

The reflection light detector 11 may also be configured to determine the location and/or direction of the light L reflected to the vehicle window 21. The control device 10 can then generate the control signals S depending on the determined location and/or the determined direction and, for example, can cause the laser scanner 22 to be deactivated only if the light L threatens to reach the eyes of vehicle occupants according to the place where it hits the vehicle window 21 or according to its direction.

In the exemplary embodiment example shown, the system 1 also contains a direction of view detection device 12 for determining the direction of view of one or more occupants of vehicle 2. The control device 10 is configured to generate the control signals S also depending on the direction of view of a vehicle occupant determined by the direction of view detection device 12. In particular, the control device 10 may generate the control signals depending on the determined direction of view in relation to the determined location and/or the determined direction of the light L reflected to the vehicle window 21. In this way, the system 1 can have an even more selective effect and may ensure that the laser scanner 22 is deactivated (if appropriate temporarily) only in really relevant situations.

The reflection light detector 11 can, for example, be a front-facing IR camera mounted in vehicle 2 near the head of a driver of vehicle 2, as shown schematically in FIG. 1. The IR camera can then directly observe the windshield 21 or a relevant section of it and, if appropriate, detect incident reflected light L.

However, it is also possible that the vehicle window 21 is coated with a fluorescent agent 3, which initially makes invisible light L visible in a wavelength range used by the laser scanner 22. In such an embodiment variant, the reflection light detector 11 can be a camera sensitive to the visible spectral range, which is directed from the inside towards the vehicle window 21 in order to detect the light L that is “translated” into the visible spectral range by the fluorescent agent.

Deviating from the schematic representation in FIG. 1, the reflection light detector 11 may, for example, also contain an interior camera directed into the vehicle interior, such as a driver's camera directed at the driver's face. The interior camera is configured to detect the reflected light L on the basis of a spectral property after it has passed through the vehicle window 21 into a vehicle interior of vehicle 2 and has been reflected and/or scattered on a structure in the vehicle interior and/or on a vehicle occupant, such as the driver's face or forehead. So the internal camera can for example observe the driver's face. If the interior camera perceives light in a relevant spectral range with a certain minimum intensity, the control device 10 can output a control signal S to attenuate or deactivate the laser scanner 22.

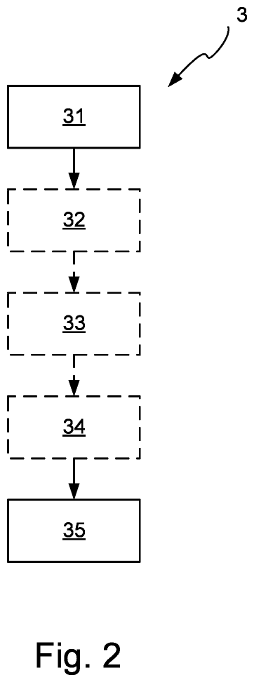

FIG. 2 shows a schematic flow diagram of a method 3 for increasing the eye safety of occupants of a vehicle 2 which is equipped with a laser scanner 22. The method 3 may correspond to the mode of operation of the system 1 from FIG. 1 described above. In other words, the method 3 can be carried out by the system 1 or the system 1 can be configured to carry out the method 3.

Accordingly, the method includes in particular the following steps, which are schematically shown in FIG. 2 in the form of blocks 31, 35: detecting 31, by a reflection light detector 11, reflected light L emitted by the laser scanner 22 and reflected from an object 4 located outside vehicle 2 to a vehicle window 21 of vehicle 2; and generating 35, by a control device 10, control signals S to influence the light emission of the laser scanner 22 depending on the detection of the reflected light L by the reflection light detector 11.

As an optional further step 32 of the method, it may also be provided that a location and/or direction of the light L reflected to the vehicle window 21 is determined. The generation 35 of the control signals S can then be carried out depending on the determined location and/or the determined direction of the light L.

Alternatively or in addition, as a further optional step 33 of the method it may be provided that an eye position and/or a direction of view of one or more vehicle occupants is/are determined. In this case, generating 35 the control signals can be carried out depending on the determined eye position and/or depending on the determined direction of view of the vehicle occupant(s).

Based on the optional steps 32 and 33 of the method, a further optional step 34 can be a comparison of the determined eye position and/or direction of view of the vehicle occupant(s) with the determined location and/or with the determined direction of the light L reflected to the vehicle window 21. The control signals S can then be generated depending on the determined eye position and/or direction of view in relation to the determined location and/or the determined direction of the light L reflected to the vehicle window 21.

Blocks 32, 33, 34 are shown in dotted lines in FIG. 2 to illustrate that they are optional steps of the method 3.

Further details and possible forms of the method 3 correspond to the explanations of the system 1 described above.

1-12. (canceled)

13. A system for increasing eye safety of occupants of a vehicle equipped with a laser scanner, comprising:
a reflection light detector configured to detect reflected light emitted by the laser scanner and which has been reflected from an object located outside the vehicle onto a vehicle window of the vehicle; and
a control device configured to generate control signals depending on the detection of the reflected light by the reflection light detector for influencing a light emission of the laser scanner.

14. The system according to claim 13,
wherein the control device is configured to, depending on the detection of the reflected light, generate the control signals to reduce an intensity of the light emitted by the laser scanner or to deactivate the laser scanner.

15. The system according to claim 13,
wherein the control device is configured to generate the control signals depending on an intensity of the reflected light detected by the reflection light detector.

16. The system according to claim 13,
wherein the control device is configured to determine a location and/or direction of the reflected light reflected to the vehicle window, and to generate the control signals depending on the determined location and/or the determined direction.

17. The system according to claim 16, comprising:
an eye position and/or direction of view detection device,
wherein the control device is configured to generate the control signals depending on an eye position and/or direction of view of a vehicle occupant determined by the direction of view detection device.

18. The system according to claim 17,
wherein the control device is configured to generate the control signals depending on the determined eye position and/or direction of view in relation to the determined location and/or to the determined direction of the reflected light reflected on the vehicle window.

19. The system according to claim 13, comprising:
an eye position and/or direction of view detection device,
wherein the control device is configured to generate the control signals depending on an eye position and/or direction of view of a vehicle occupant determined by the direction of view detection device.

20. The system according to claim 13,
wherein the reflection light detector is configured to detect light in a visible spectral range and/or in an infrared spectral range.

21. The system according to claim 13,
wherein the reflection light detector is configured to detect the reflected light based on a spectral property.

22. The system according to claim 13,
wherein the reflection light detector comprises an internal space camera which is configured to detect the reflected light on a basis of a spectral property after it has penetrated through the vehicle window into a vehicle interior of the vehicle and has been reflected and/or scattered at a structure in the vehicle interior and/or on a vehicle occupant.

23. A vehicle comprising:
a laser scanner;
a vehicle window; and
the system according to claim 13,
wherein the reflection light detector is configured to detect the reflected light that has been emitted by the laser scanner and that has been reflected from the object located outside the vehicle onto the vehicle window.

24. The vehicle according to claim 23,
wherein the vehicle window is provided with a fluorescent agent which initially makes invisible reflected light in a wavelength range used by the laser scanner visible.

25. A method for increasing eye safety of occupants of a vehicle equipped with a laser scanner, the method comprising:
detecting, by a reflection light detector, reflected light that has been emitted by the laser scanner and reflected by an object outside the vehicle onto a vehicle window of the vehicle; and
generating, by a control device, control signals for influencing a light emission of the laser scanner depending on the detection of the reflected light by the reflection light detector.
